(19) United States
(12) Patent Application Publication
(10) Pub. No.: US 2009/0313067 A1
(43) Pub. Date: Dec. 17, 2009

(54) SYSTEM AND METHOD FOR BUSINESS TO BUSINESS SALES AND MARKETING INTEGRATION

(75) Inventors: David Costa, San Francisco, CA (US); Mark Heisten, Woodside, CA (US); Jennifer Steinmann, San Francisco, CA (US)

Correspondence Address: Visa USA c/o Duane Morris LLP;Attn: James Sze, Esq., 101 West Broadway, Suite 900, San Diego, CA, 92101, US

(73) Assignee: Visa U.S.A. Inc., San Francisco, CA (US)

(21) Appl. No.: 12/437,849

(22) Filed: May 8, 2009

Related U.S. Application Data
(60) Provisional application No. 61/060,541, filed on Jun. 11, 2008.

(51) Int. Cl. G06Q 10/00

(52) U.S. Cl. 705/7

(57) ABSTRACT

A system for marketing and sales in a business-to-business environment is disclosed. The system includes a close integration of sales and marketing personnel of an organization maximize awareness of the organization in the minds of prospective customers and to be considered as a possible supplier when needs arise. This integration further is utilized to enhance the organization's response to RFP's issued by prospective customers. The system is used to identify unmet customer needs and solutions, to utilize cross-functional teams to more effectively respond to RFPs, and to collaborate with the customer at all levels to achieve and maintain a positive customer experience. The system also provides a variety of consolidated information tools to sales and marketing groups to optimize all oral and written interactions with prospective customers as well as current customers. Examples of such tools include an RFP Response Wizard, a Win Improvement Toolkit, a Learning from Losses newsletter, and a Customer Experience Kit, among others. Success metrics are also used to track the effectiveness of marketing/sales efforts.

### CROSS-REFERENCE TO RELATED APPLICATION

This is a non-provisional of pending U.S. Provisional Patent Application Ser. No. 61/060,541, titled “Business to Business Sales and Marketing Integration Method,” filed Jun. 11, 2008, by David Costa et al., the entirety of which application is incorporated by reference herein.

### FIELD OF THE INVENTION

Aspects of the present invention generally relate to methods of increasing sales by improving the acquisition of new customers and enhancing satisfaction and loyalty among existing customers, and more particularly to methods for integrating sales and marketing functions of a business to facilitate the sales process, and to foster long term customer acquisition, satisfaction, and loyalty.

### BACKGROUND

Sales and marketing functions exist within most companies, often with little or no integration. The goal of business to business (B2B) marketing should be to help make the sales process easier, to help open doors with prospective clients, close deals and thereafter make clients feel good about their decisions.

### SUMMARY

In one aspect, a process is disclosed for closely integrating sales and marketing functions in order to improve acquisition of new customers and enhance loyalty among existing customers to a company, thereby increasing both short term and long term sales to that customer and others.

A machine readable storage device tangibly embodying a series of instructions executable by a machine to perform a series of instructions is disclosed. The instructions may comprise: collecting and storing business data regarding a sales prospect in a machine readable storage medium; providing said business data to individual members of a cross-functional team, the cross-functional team comprising individuals from at least marketing and sales departments of an organization; using said business data, and information regarding at least one product or service provided by the organization, to encourage the sales prospect to issue a request for proposal to the organization; generating a response to the request for proposal using a response engine that uses at least a portion of said stored business data to automatically populate a response template; and submitting said response to the sales prospect.

A marketing and sales method is disclosed for facilitating business-to-business relationships. The method may comprise: collecting and storing business data regarding a sales prospect in at least one database; providing said business data to a member of a cross-functional team, the cross-functional team comprising marketing and sales personnel of an organization; using said business data, and information regarding at least one product or service provided by the organization, to encourage the sales prospect to issue a request for proposal to the organization; generating a response to the request for proposal using a response engine that uses information from said database to automatically populate a response template using at least a portion of said stored business data; and submitting said generated response to the sales prospect. The step of providing said business data to a member of a cross-functional team may comprise retrieving data from said database and displaying said processed data to at least one of said members on a display.

A method for facilitating business-to-business relationships is disclosed for use in a system comprising a computer having a processor, a computer-readable medium associated with the processor, and a display. The method may comprise: collecting and storing business data regarding a sales prospect, at least a portion of said business data being stored in a computer readable storage medium; providing said business data to individual members of a cross-functional team, the cross-functional team comprising marketing and sales personnel of an organization; using said business data and at least one of information regarding market trends, sales prospect needs, information regarding at least one competitor product, and information regarding at least one product or service provided by the organization, to encourage the sales prospect to issue a request for proposal to the organization; wherein information regarding sales prospect needs is obtained using a questionnaire submitted to the sales prospect, the questionnaire generated by the cross-functional team; generating a response to the request for proposal using a processor-based response engine that uses at least a portion of said stored business data to automatically populate a response template; and submitting the response to the sales prospect. The step of providing said business data to individual members of a cross-functional team may comprise retrieving data from said computer readable storage medium, performing a first computer process on said data using the processor, and displaying said processed data to at least one of said members using the display.

### BRIEF DESCRIPTION OF THE DRAWINGS

These and other features and advantages of the present invention will be more fully disclosed in the following detailed description of an embodiment of the invention, which is to be considered together with the accompanying drawings wherein like numbers refer to like parts, and further wherein:

FIG. 1 is a flow chart illustrating the disclosed method;

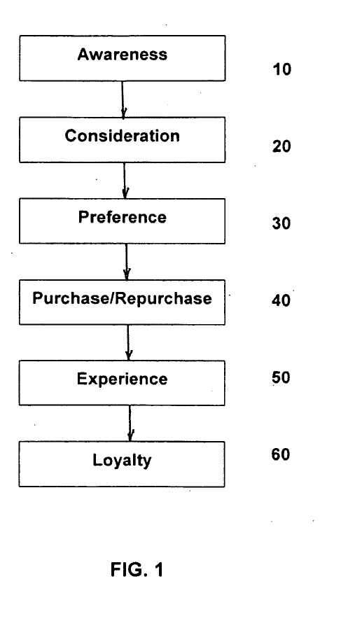

FIG. 2 is a chart showing exemplary tools for use with the disclosed method;

FIG. 3 illustrates a system according to an embodiment of the present invention; and

FIG. 4 is a functional block diagram of an example of a computer for use in the system of FIG. 3.

### DETAILED DESCRIPTION

The inventors have recognized a common problem with many businesses, namely that there is either no linkage between marketing and sales departments, or the interaction is tenuous or poorly developed and lacking in common direction and goals. Thus, it would be advantageous to have a practice model that better integrates B2B sales and marketing. It would also be advantageous to have a practice model that supports client and customer acquisition and retention more effectively.

A method is disclosed for tightly integrating various activities of sales and marketing personnel in a business organization in order to enable the organization to more effectively obtain new customers, to retain those customers the organization already has, and to enhance continuing or new sales to current customers. The overall method intends to provide integrated action to take customers from the initial “awareness” phase, through the sales phase, and to thereafter build and maintain the customer's loyalty to the organization.

Throughout the application the terms “organization,” “client” and “prospect” will be used. These terms should be interpreted broadly. In one exemplary embodiment, the organization may be a credit card company who offers card services to individual consumers and/or businesses through a “client” financial institution. The client financial institution may deliver products and services to end users, who are often small or large companies. The companies may be referred to as “prospects” “prospective customers,” or “customers.” These terms may also include companies who are not yet customers, as well as existing customer companies who may be cross-sold products and services they do not yet have.

Additionally, it is noted that while the organization may have separate sales and marketing departments who may work together, the client financial institutions also will in many cases have sales and marketing departments of their own. The method is not limited to use within a single organization or client, but may span the gap so that the organization and client can team to provide the most effective effort at each part of the method.

Awareness

At block 10, a prospect becomes aware, or is made aware, of the organization's existence and its ability to provide product and/or service capabilities in an area of interest to the prospect. Traditional marketing techniques are often used to generate general market awareness of an organization's products and/or services and are also used to open the sales pipeline. Often such marketing has as its goal the identification of an unmet need of one or more prospective customers and to seek or offer solutions, or to increase knowledge of potential solutions.

Many times a prospect is unaware that an unmet need exists. Moreover, even if the prospect is aware that a need exists, he or she may be unsure of the value of implementing a particular solution aimed at meeting that need. For example, in the market for consumer credit cards, a particular card-issuer may be uncertain about the financial efficacy of implementing a card program or of enhancing an existing card program. Traditionally, organizations may attempt to overcome such resistance by providing the prospect with examples, information and data that illustrate real-world success of the program achieved by similar companies that have implemented or enhanced their card program in a similar manner.

To enhance awareness 10, the disclosed method may generate and maintain prospect awareness through the development of a robust content library that may contain advertising material, public relations (PR) materials, case studies that may be of interest to the prospect, hot topics materials that may be of interest to a prospect, white papers, how-to guides, and benchmarks. Further, the content library may contain a collection of customer and competitor insights that may be interpreted in a manner helpful to sales and marketing personnel in approaching a prospect. For example, a white paper may describe current customer or competitor experiences with a product or service that the organization would like to sell to one or more prospects. White papers can be provided to the prospects to make them aware of the product or service, or to enable them to see how other companies have benefited from adopting that product or service. It will be appreciated that the development of a “content library” is just one example of how this could be done.

In some embodiments, the content library is stored in a machine readable storage medium accessible via a network server. The white papers may be provided to the prospects via electronic mail, or by sending the prospect a uniform resource identifier (URI) or uniform resource locator (URL), with which the prospect can link to the content library using a computer processor equipped with a browser.

In addition, sales and marketing personnel may jointly define and review all marketing materials, service demonstrations and the like, and may jointly identify, plan and execute tradeshows, speaking engagements, PR opportunities and potential hot topics. In some embodiments, this joint review may be facilitated by electronic delivery of the marketing materials to each individual whose approval is required to release the materials, and/or a computer application program having an approval module that collects a signature from each approving party before release can occur.

Success metrics for these awareness enhancement techniques include awareness measurements (e.g., by polling prospects or others), tabulating hits on the organization's website, website impressions, e-mail inquiries, “contact us” inquiries, web-based leads, tabulations of attendance at organization-sponsored webinars and other events such as customer education initiatives. A customer relation management system can also be used to track meetings with prospects, to indicate what was discussed at such meetings, and to generally identify relationship milestones.

Consideration

An organization should quickly address prospect needs in order to foster good relationships and drive serious “consideration” of the organization as part of the prospect's purchase process. At block 20, a prospect may issue a request for information (RFI), request for quote (RFQ) and/or a request for proposal (RFP) in response to a desire or need for a product or service. In response, the organization identifies solutions that ideally will result in the outcome or outcomes desired by the prospect. For example, a prospect may initiate a cost reduction or payments and card program inquiry, or may seek information regarding procurement-to-payment or other technology issues that may enhance the prospect's use of electronic forms of payment. Traditionally, organizations react to such requests by rapidly identifying the prospect's needs, determining the prospect's general profile and attempting to influence the prospect's concerns or even to identify additional needs.

To enhance the consideration phase 10, the disclosed method may include developing a “prospect diagnostic” that identifies and tailors individual sales presentations to market trends, prospect/influencer needs, potential or real barriers to adoption, potential “win themes,” and competitor messages (e.g., respond to expected prospect questions about a competitor, or address issues regarding a competitor's product/service that may be missed in the general marketplace). Sales and marketing groups may jointly develop a questionnaire that can be used with the prospect to pull from the prospect what their expectations are and also to identify whether any needs/expectations exist that the prospect may be unaware of. Sales and marketing groups may also agree on template sales presentation content, and may jointly develop a cross-functional sales presentation (e.g., a “pitch event”). In some embodiments, the questionnaire is embodied in an interactive computer program, which causes display of questions to the prospect and inputs responses from the prospect, which are stored in a computer readable storage medium.

Success metrics for this phase include tabulation of lead quantity and quality (e.g., quality may be based on different attributes of the prospect such as number of years in business, number of employees, past credit history with a client financial institution, and the like). Additionally, tabulations of customer education invitations, tabulations of RFI/RFP/RFQ invitations, and perception tracking may also be utilized.

Preference

An organization should articulate clear, differentiating value as compared to competitors in order to increase prospect preference and increase short-listing. At block 30, the organization may effect the prospect's preferences by proactively negotiating the elements of the organization's products or services that meet the prospect's needs. Often a prospect may begin to develop a preference when they issue an RFI/RFP/RFQ. In response, organizations often attempt to identify “win themes,” tailor response their templates, engage clients in needs-based interactions, and cultivate relationships with the prospect's procurement personnel. Since some sales processes can take many months to conclude, often there are substantial interactions between the prospect and the organization between the time the RFI/RFP/RFQ is issue and the time the organization files its response. During that time, the prospects' needs can change (many times these needs are modified based on informed interactions with the organization).

To facilitate the preference phase 30, the disclosed method may include, for example, the development and use of a “Response Wizard” that integrates a variety of information that can be used to respond to, and inform, the prospect's preference. Thus, in one exemplary embodiment, the Response Wizard may include information regarding recent trends (e.g., experiences of other similar businesses). Additionally, the Response Wizard may be used to tailor the organization's response to an RFI/RFP/RFQ to include only that information that is perceived to directly apply to the prospect's needs, and eliminates irrelevant or less valuable information. The Response Wizard may include one or more processor-based algorithms that enforce brand and language consistency throughout the presentation, and produce a template response. Information relating to desired pertinent brand and other language may be stored in a computer readable medium and used by the processor to enforce the aforementioned consistency. The Response Wizard may also control brand and language consistency throughout the response by recognizing patterns in data input by one or more users and/or information loaded into the template from one or more of the databases. In addition, brand and language consistency may be automatically imposed (i.e., changes may be automatically implemented), or they may be automatically identified or highlighted so that the user can select or reject the suggestion. The Response Wizard may tailor content of the response to at least one characteristic of the sales prospect, such as whether the prospect is a credit card company, is a company who is not yet a customer, or is an existing customer who may be cross-sold products and services they do not yet have. For example, if the prospect is an existing customer, then the Response Wizard may load a more streamlined set of background information relating to the company into the template, and may stress benefits already provided to the customer by the company. By contrast, if the prospect is a new customer, more basic, detailed information sets regarding the company may be loaded into the template.

As part of this phase, sales and marketing personnel may hold joint win or “best and final” planning discussions, and/or form cross-functional response teams. For example, a cross-functional team may include individuals from sales, such as a relationship manager, technical sales team manager, individuals from the marketing team, product developers, post-sales servicing personnel, as well as account and customer service managers. The key is to provide a response (whether it be written or in a presentation environment) that shows the prospect how the organization will continue to meet their needs from cradle to grave. One or more members from the cross-functional group may participate, along with sales, in oral presentations and demonstrations to prospects.

Success metrics for this phase include tabulations of oral presentation invitation frequency, demonstration invitation frequency, and cost per invitation.

Purchase/Repurchase

A quick and seamless transition of information regarding customer purchase decisions should occur between sales and marketing so that the information can be rapidly reused in further marketing strategies for the same or different prospects. At block 40, the organization responds to the prospect's decision to execute a new contract or to renew an existing contract. In practice, a prospect may cancel an RFP or other formal inquiry and select a solution from a range of options. Regardless of whether the prospect elects the organization's product/service or that of the competition, the organization may attempt to discuss the purchasing rationale with key customer personnel in order to understand the purchasing rational. Additionally, sales and marketing departments may hold regular post-mortem discussions to assess root causes of the win or loss.

To facilitate this purchase/repurchase phase 40, the disclosed method may include, for example, a “Win Improvement Toolkit” that may include a prospect questionnaire which includes specific questions aimed at assessing the effectiveness of all or some parts of the organization's response to the prospect's RFI/RFP/RFQ. A post-mortem session facilitation guide may also be included in the Toolkit. This guide may be helpful to obtain the greatest benefit from post-mortem meetings with the prospect. For example, the organization may bring members of the cross-functional team (sales, product development, marketing, account management, customer service) to meet with the prospect (who at this point either is a customer or has elected a competitor's product/service), to find out what the organization did right and what it did wrong. The Toolkit may further comprise data capture templates to enable the fast and efficient collection of the information at the meeting.

In addition, the Toolkit may include a “Learning from Losses” communications that can be used to quickly and easily disseminate information about what things did and didn't work in the sales process. This information may be distributed throughout the relevant departments to ensure that lessons learned reach the appropriate individuals in the organization and can be incorporated into new interactions with the same or other prospects. It will be appreciated that a newsletter is only one example of a format in which such information can be disseminated, and others, such as e-mail, limited organizational intranet postings (e.g., available to one or more teams), and the like also may be used. A cross-functional team (either the same team as was assembled for the sales process, or a different team) may capture information for this “Win Improvement Toolkit.” One function of the team would be to hold cross-functional post-mortem discussions, and to jointly interpret win/loss trends. This information can be included in the newsletter or e-mail message(s) so that it may immediately be used by individuals in the organization responsible for future presentations to the same or other prospects.

Success metrics include formulation of a win ratio (e.g., number of wins divided by number of presentations), win rationale tracking (e.g., tabulations of the number of times a prospect cited a particular reason for selecting the organization's product/service), and cost per win.

Experience

Assuming that the organization was successful and the prospect has become a customer (or is a repeat customer), it may be important to control the customer's continuing experience with the organization and its people to ensure that any problems that may arise can be quickly and effectively addressed. Often, a customer may plateau at a lower than expected volume (as compared to information originally provided during the RFI/RFP/RFQ process). Further, the customer may request assistance in achieving one or more of the objectives that were defined in the original business case. In the experience phase 50, the organization may attempt to monitor the customer experience, to proactively address barriers to loyalty, and to continue to deliver value and new ideas. Properly applied, these techniques can assure the maintenance of current business with the customer, and can also lead to future additional business with the customer.

Block 50 of the method may include, for example, the implementation of a “Customer Experience Kit,” that may include a welcome kit. A welcome kit may be provided to the customer by the organization's account services manager, and may include such information as a list of names and phone number of individuals to contact should certain problems or issues arise. The welcome kit may also include frequently asked questions (FAQs) about common relevant topics, and other content that makes the customer's experience going forward as positive as possible.

The Customer Experience Kit may further include one or more hot topics that discuss the most recent relevant trends and the like. Additionally, a value delivered booklet may be provided that includes a summary of the organization's capabilities (e.g., services that enable the customer to perform a certain function, provide reports that can give the customer new insight into spending patters, etc.). The Kit may further include a Recommitment to Serve message that reinforces to the customer the organization's post-win resolve to provide superior support.

Sales and marketing personnel may customize the Customer Experience Kit and the Welcome Kit, for example, to fit the specific customer's profile (again, eliminating irrelevant information), and may also hold joint planning sessions on a Value Delivered Booklet. They may also hold a joint planning session on the Recommitment to Serve message.

Success metrics in the “Experience” category include expansion initiative frequency (i.e., how often the customer seeks to enhance or expand a given contract), and propensity to attrite. Propensity to attrite may be determined by monitoring the number of customer complaints received about a particular issue, how quickly the issue was resolved, and the like. A determination can be made, based on this information, about how likely the customer may be to leave.

Loyalty

Existing customer data as well as customer references may be mined to harvest the value of customer loyalty. Customer loyalty may often show itself in a prospect extending a contract, conducting abbreviated new sourcing efforts when a contract expires, and/or is willing to act as a positive reference for the organization. Traditional organization efforts at building and maintaining loyalty include continuing to execute high standards of service, creating case studies based on the customer's experience, cultivating personal/professional relationships with customer personnel, and identifying cross-sell and expansion opportunities. If an existing customer has a positive experience with the organization, and is will to provide a testimonial or be the subject of a white paper, then the organization may utilize them as a potential source of new business.

To this end, at block 60 the disclosed method includes development of cross-sell models which take advantage of existing relationships with the customer to sell to other groups or divisions within the customer's organization. Additionally, the company and customer may jointly develop testimonials and case studies based on the customer's positive experience with the organization and its products or services. In many cases, the customer may act as a reference for use in selling to other prospects. To most effectively implement this phase, sales and marketing individuals may jointly prioritize and plan speaking engagement topics, and hold cross-functional, cross sell planning discussions.

Success metrics including cross-selling lead quantity and quality, cross sell/repeat wins, referral quantity and overall quality.

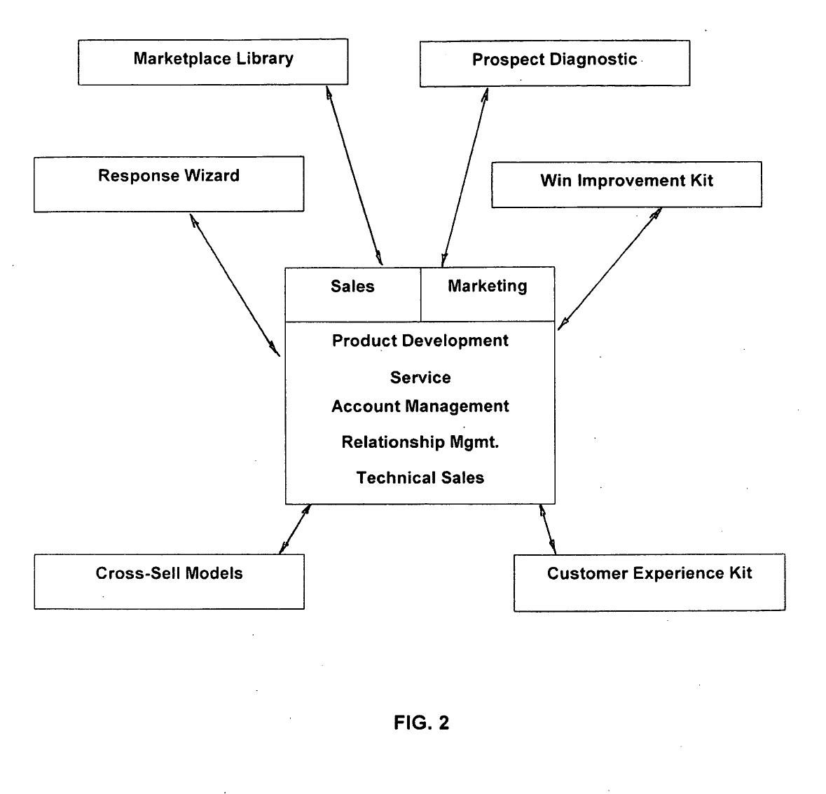

In addition to the above, sales and marketing personnel also may work together to explore potential new tools and practices to tighten integration. Examples of such tools include Marketplace Library, Prospect Diagnostic, Response Wizard, Win Improvement Kit, Customer Experience kit, Cross-Sell Models, some of which have been described above, and which are summarized below. As shown in FIG. 2, these tools may be available for use by the cross-functional team, which may include individuals from sales, marketing, product development, customer service, account management, and others.

Marketplace Library—may include a comprehensive collection of industry and prospect profiles stored in a machine readable storage medium. In some embodiments, the marketplace library data are indexed and stored by a database management system accessible by a network server. Benefits of such a marketplace library may include growth of leads and/or increase of lead quality, as well as reduced overall cost per lead.

Prospect Diagnostic—may include a questionnaire (which may be automated using a survey tool such as SurveyMonkey by Survey Monkey Corporation of Portland, Oreg.), and automated output with links to collaboration opportunities in an effort to find areas and events in which marketing/sales/product development/account management can collaborate on sales opportunities. For example, once a prospect is identified, information may be input into diagnostic to locate key individuals to form the cross-functional group who would prepare and/or participate in a prospect pitch or response to RFI/RFP/RFQ. Benefits of a prospect diagnostic may include increased RFP invitations, and reduced cost per invitation.

Response Wizard—may include a customizable questionnaire that provides RFI/RFP/RFQ content that is tailored to the customer's profile and needs. The Response Wizard may be used to unitize an organization's responses to such requests to implement the latest “lessons learned,” etc. Core benefits include increased short-list invitations, and reduced cost per invitation.

Win Improvement Kit—may include materials and information to support regular, consistent analysis of wins and losses that may then be used for rapid adjustment of approaches and messages used by the organization. Core benefits include improved win ratio and reduced cost per win.

Customer Experience Kit—may include materials to support regularly engaging the client in thought provoking discussions regarding their experience with the organizations products/services and support personnel. May also be used to communicate value delivered (i.e., to remind the customer of the benefits that the organization provides). Core benefits are increased retention, and existing program growth.

Cross-Sell Models—may include algorithms to help identify robust leads from existing client relationships. For example, a prospect that currently has a commercial real estate loan with a client (e.g., bank) of the organization may be a good prospect based on their high credit rating and the long term deep relationship with that bank. This is an example of how information from the client's sales and marketing personnel can work with the sales and marketing groups of the organization to jointly develop prospects. Core benefits are increased lead/lead quality and reduced cost per lead.

Embodiments described herein may be automated by, for example, tangibly embodying a program of instructions upon a computer readable storage medium, capable of being read by machine capable of executing the instructions. A general purpose computer is one example of such a machine. Examples of appropriate storage media are well known in the art and would include such devices as a readable or writeable CD, flash memory (e.g., thumb drive), various magnetic storage media, and the like.

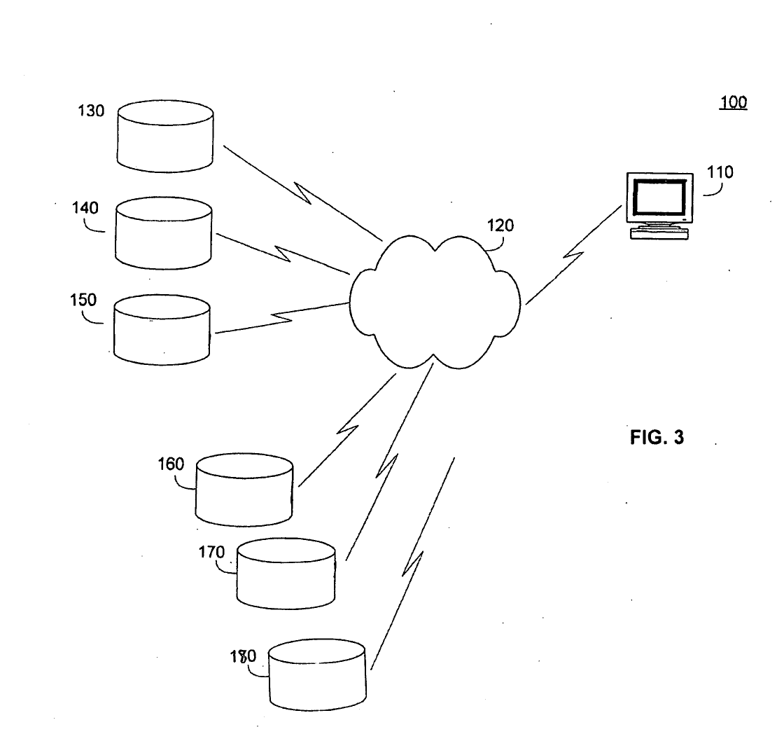

Referring now to FIG. 3, an example of a system according to an embodiment of the present invention is disclosed. The system 100 may include a computer 110 configured to enable the assembly of a variety of information written to, stored in, and retrieved from a plurality of databases 130-180. It will be appreciated that the computer 110 is not limited to any particular type of computer, but may be a server, a personal computer, a personal digital assistant, a terminal, a special purpose communication device, a telephone, a wireless telephone, and the like, or other appropriate communication device. The computer 110 also may be connected to a network 120 which can include a Wide Area Network (WAN), Local Area Network (LAN), or other appropriate network configuration or combination of network configurations. The network 120 can include, for example, the Internet. The network 120 may be coupled to, or otherwise be in communication with, databases 130-180.

In one exemplary embodiment, the computer 110 may access a first database 130 containing a content library. The content library may contain information relating to or comprising advertising material, public relations materials, case studies, hot topics, white papers, how-to guides and benchmarks, collections of customer and competitor information. The first database 130 may further comprise information used to build success metrics, such as tabulations of hits on the organization's web site, tabulations of attendance at organization-sponsored webinars and other events such as customer education initiatives, and the like.

The computer 110 may similarly access a second database 140 that contains a “prospect diagnostic library.” The prospect diagnostic library may include information that can be used to identify and tailor individual sales presentations to market trends, prospect/influencer needs, barriers to adoption, potential “win themes” and competitor messages. This information can also be used to develop prospect questionnaires, and/or to develop template sales presentation content. The second database 140 may further include information that can be used to build success metrics, such as tabulations of lead quantity and quality, customer education invitations, RFI/RFP/RFQ invitations, perception tracking, and the like.

The computer 110 may further access a third database 150 that contains a “response wizard” library that integrates a variety of information for responding to prospect preferences. This database may include information regarding recent industry trends, information that can be used to tailor an RFI/RFP/RFQ to include only those materials that directly apply to a particular prospect, and to eliminate less relevant or irrelevant information. The third database 150 may further comprise information helpful in building success metrics, including tabulations of oral presentation invitation frequency, demonstration invitation frequency, cost per invitation, and the like.

The computer 110 may also access a fourth database 160 that contains a “win improvement toolkit” library. The win improvement toolkit library may include information used to build a prospect questionnaire which includes specific questions aimed at assessing the effectiveness of all or some part or parts of an organization's response to the prospect's RFI/RFP/RFQ. The fourth database 160 may also include information for developing a post-mortem session facilitation guide that can be used to in post-mortem meetings with a prospect, as well as data capture templates to enable efficient collection of information at such meetings. The fourth database 160 may further include information helpful in building success metrics, including win ratios (number of wins divided by number of presentations), win rational tracking (tabulations of the number of times a prospect cited a particular reason for selecting the organization's product/service), and cost per win.

The computer 110 can also access a fifth database 170 that contains a “customer experience kit” library. The customer experience kit library may include information used to develop a welcome kit that can be provided to a new customer. The welcome kit may provide a comprehensive list of names and phone numbers of individuals to contact should certain problems or issues arise, as well as a lost of frequently asked questions and their answers. The library may further include hot topics that discuss recent relevant trends, a value delivered booklet that includes a summary of the organization's capabilities. The fifth database 170 may also include information helpful in building success metrics, including data regarding how often a customer seeks to enhance or expand a given contract, number of customer complaints received about particular issue, how quickly customer issues are resolved, and the like.

The computer 110 can also access, via the network 120, a sixth database 180 that contains information for developing cross-sell models, including customer testimonials and case studies. The sixth database 180 may also include information for developing success metrics, including data representative of cross-selling lead quantity and quality, cross sell/repeat wins, referral quantity and quality.

In one embodiment, the computer 110 may be configured to retrieve information from one or more of the databases 130-180, either directly or via the network 120, to compile information for or about a particular prospect based on a predetermined list or criteria supplied by a user.

In addition, although the connection between the computer 110 and all of the databases 130-180 is shown in FIG. 3 as occurring via network 120, it will be appreciated that in other embodiments some or all of the databases could simply reside on the computer 110 without the need to access a network 120. In addition, certain of the information forming one or more of the databases 130-180 may be obtained manually by looking the values up in a printed medium, and then manipulating those values (e.g., manually or electronically) to obtain the desired compilation of information about one or more prospects.

Once the computer 110 has retrieved or otherwise obtained all of the data from the relevant databases 130-180, the computer 110 may be programmed to generate one or more reports or outputs of the collected data. These reports or outputs can be provided or accessed by interested parties (either via printed report or electronic display) that can, in turn, make actionable decisions based on the reported or outputted information.

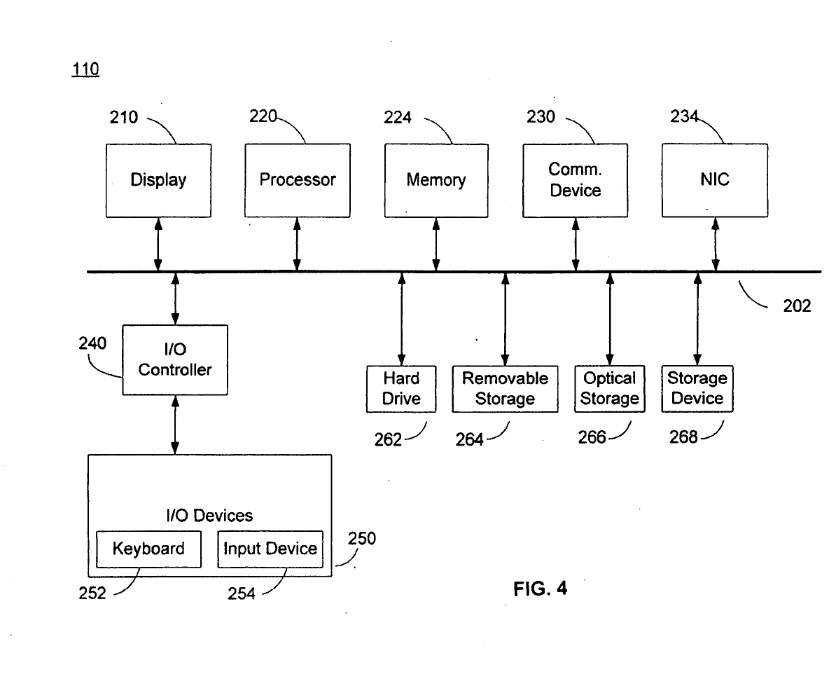

Referring now to FIG. 4, a functional block diagram is provided as an example of a computer 110 which can be used in the system 100 of FIG. 3. The computer 110 can include a display 210, a processor 220, memory 224, a communication device 230, a network interface Card (NIC) 234, an I/O controller 240, a hard drive 262, one or more removable storage drives 264, which can include a floppy drive, and an optical storage 266, and one or more storage devices 268. The I/O controller 240 can be configured to interface with one or more I/O devices 250, which can include a keyboard 252 and some other input device 254. The NIC 234 can couple the computer 110 to a network, such as the network shown in FIG. 3. The various elements within the computer 110 can be coupled using one or more computer busses 202. The one or more storage devices 268 can include, but are not limited to, ROM, RAM, non-volatile RAM, flash memory, magnetic storage, optical storage, tape storage, hard disk storage, and the like, or some other form of processor readable medium. The memory 224 and the storage devices 268 can include one or more processor readable instructions stored as software. The software can be configured to direct the processor 220 to perform some or all of the functions within the computer 110 within the system 100 of FIG. 3. The software can include stand alone software executed by the processor 220, or the software can run within an operating system or within another software program. Of course, not every computer 110 includes all of the modules or elements depicted in the embodiment of FIG. 4. Some of the elements can be optional and may be omitted. Other elements not shown can be added to the computer 110.

While an example of the invention has been described with reference to the above embodiments, various modifications and changes can be made without departing from the spirit of the invention. Accordingly, all such modifications and changes are considered to be within the scope and range of equivalents of the appended claims.

1. A machine readable storage device tangibly embodying a series of instructions executable by a machine to perform a series of instructions, the instructions comprising:
collecting and storing business data regarding a sales prospect in a machine readable storage medium;
providing said business data to individual members of a cross-functional team, the cross-functional team comprising individuals from at least marketing and sales departments of an organization;
using said business data, and information regarding at least one product or service provided by the organization, to encourage the sales prospect to issue a request for proposal to the organization;
generating a response to the request for proposal using a response engine that uses at least a portion of said stored business data to automatically populate a response template; and
submitting said response to the sales prospect.

2. The machine readable storage device of claim 1, wherein the step of generating a response further comprises using the response engine to automatically control brand and language consistency throughout the response.

3. The machine readable storage device of claim 1, wherein the step of generating a response further comprising using the response engine to automatically tailor content of the response to at least one characteristic of the sales prospect

4. The machine readable storage device of claim 1, further comprising the instruction: obtaining a measure of an effectiveness of the response using a success metric, wherein the metric is selected from the group consisting of oral presentation invitation frequency, demonstration invitation frequency, and cost per invitation.

5. The machine readable storage device of claim 1, wherein the cross-functional team further comprises individuals from product development, marketing, account management, and service departments of the organization.

6. The machine readable storage device of claim 5, wherein the cross-functional team further comprises individuals from sales and marketing departments of a client company of said organization.

7. The machine readable storage device of claim 1, further comprising obtaining information from the sales prospect regarding a purchase decision made by the sales prospect based on the organization's response to the request for proposal, said information including the purchaser's rationale for the purchase decision.

8. The machine readable storage device of claim 7, further comprising generating a cross-sell model that includes information selected from the list consisting of a customer testimonial, a customer case study, and a customer endorsement.

9. A marketing and sales method for facilitating business-to-business relationships, comprising:
collecting and storing business data regarding a sales prospect in at least one database;
providing said business data to a member of a cross-functional team, the cross-functional team comprising marketing and sales personnel of an organization;
using said business data, and information regarding at least one product or service provided by the organization, to encourage the sales prospect to issue a request for proposal to the organization;
generating a response to the request for proposal using a response engine that uses information from said database to automatically populate a response template using at least a portion of said stored business data; and
submitting said generated response to the sales prospect;
wherein the step of providing said business data to a member of a cross-functional team comprises retrieving data from said database and displaying said processed data to at least one of said members on a display.

10. The method of claim 9, wherein the step of generating a response further comprises using the response engine to automatically control brand and language consistency throughout the response.

11. The method of claim 9, wherein the step of generating a response further comprising using the response engine to automatically tailor content of the response to at least one characteristic of the sales prospect

12. The method of claim 9, further comprising obtaining a measure of an effectiveness of the response using a success metric, wherein the success metric is selected from the group consisting of oral presentation invitation frequency, demonstration invitation frequency, and cost per invitation.

13. The method of claim 9, wherein the cross-functional team further comprises product development, marketing, account management, and service department personnel of the organization.

14. The method of claim 9, wherein the cross-functional team further comprises sales and marketing department personnel of a client company of said organization.

15. The method of claim 9, further comprising obtaining information from the sales prospect regarding a purchase decision made by the sales prospect based on the organization's response to the request for proposal, said information including the purchaser's rationale for the purchase decision.

16. The method of claim 15, further comprising generating a cross-sell model that includes information selected from the list consisting of a customer testimonial, a customer case study, and a customer endorsement.

17. The method of claim 16, wherein said cross-sell model includes an algorithm for identifying one or more additional prospective customers using information obtained from said prospective customer.

18. A method for facilitating business-to-business relationships for use in a system comprising a computer having a processor, a computer-readable medium associated with the processor, and a display, the method comprising:
collecting and storing business data regarding a sales prospect, at least a portion of said business data being stored in a computer readable storage medium;
providing said business data to individual members of a cross-functional team, the cross-functional team comprising marketing and sales personnel of an organization;
using said business data and at least one of information regarding market trends, sales prospect needs, information regarding at least one competitor product, and information regarding at least one product or service provided by the organization, to encourage the sales prospect to issue a request for proposal to the organization;
wherein information regarding sales prospect needs is obtained using a questionnaire submitted to the sales prospect, the questionnaire generated by the cross-functional team;
generating a response to the request for proposal using a processor-based response engine that uses at least a portion of said stored business data to automatically populate a response template; and
submitting the response to the sales prospect;
wherein the step of providing said business data to individual members of a cross-functional team comprises retrieving data from said computer readable storage medium, performing a first computer process on said data using the processor, and displaying said processed data to at least one of said members using the display.

19. The method of claim 18, wherein the step of generating a response further comprises using the response engine to automatically control brand and language consistency throughout the response.

20. The method of claim 18, wherein the step of generating a response further comprising using the response engine to automatically tailor content of the response to at least one characteristic of the sales prospect

21. The method of claim 18, further comprising obtaining a measure of an effectiveness of the response using a success metric, wherein the success metric is selected from the group consisting of oral presentation invitation frequency, demonstration invitation frequency, and cost per invitation.

22. The method of claim 18, wherein the cross-functional team further comprises product development, marketing, account management, and service personnel of the organization.

23. The method of claim 22, wherein the cross-functional team further comprises sales and marketing personnel of a client company of said organization.

24. The method of claim 18, further comprising obtaining information from the sales prospect regarding a purchase decision made by the sales prospect based on the organization's response to the request for proposal, said information including the purchaser's rationale for the purchase decision.

25. The method of claim 24, further comprising generating a cross-sell model that includes information selected from the list consisting of a customer testimonial, a customer case study, and a customer endorsement.

26. The method of 25, wherein said cross-sell model includes an algorithm for identifying one or more additional prospective customers using information obtained from said prospective customer.
